(19) United States
(12) Patent Application Publication
(10) Pub. No.: US 2019/0008308 A1
(43) Pub. Date: Jan. 10, 2019

(54) Temperature-maintenance zero-cooking utensil

(71) Applicant: Lionel Abenin, Tremblay-en-France (FR)

(72) Inventor: Lionel Abenin, Tremblay-en-France (FR)

(21) Appl. No.: 15/644,980

(22) Filed: Jul. 10, 2017

(51) Int. Cl. A47J 27/00; A47J 45/06; A47J 36/02; A47J 37/10

(52) U.S. Cl. CPC A47J 27/002; A47J 45/068; G01K 1/14; A47J 37/10; A47J 2202/00; A47J 36/02

(57) ABSTRACT

Provided herein are kitchen utensils, in particular temperature-maintenance saucepans, frying pans, pots and woks. The temperature-maintenance zero-cooking utensil may include a small solar panel being arranged at the end of the utensil's handle, a command control system located on the top of the handle or grips of the temperature-maintenance utensils, an OFF button (circuit-breaker) arranged between the command control system and the small motor, a small motor incorporated in the handle or grips of the utensils, and cooling liquid or distilled water (Elephant's-civ technology) with its pressurized zone. Sensors and connecting pipes are arranged around the right and left sides and between the body and base of the pan. Electrical wires may connect all of the systems of the temperature-maintenance zero-cooking utensils together.

### 1. FIELD OF THE INVENTION

This new invention concerns kitchen utensils, in particular temperature-maintenance saucepans, frying pans, pots and woks.

### 2. TECHNOLOGICAL BACKGROUND

At present, all temperature-maintenance zero-cooking utensils will operate directly with all types of existing heat sources (gas, induction, halogen, glass-ceramic, etc.) so there is no need for the consumer to put his hand in his pocket with a view to making a new purchase. Temperature-maintenance zero-cooking utensils have been designed to adapt to and work with all heat sources but above all to enable the food inside the temperature-maintenance zero-cooking utensils to be safely kept.

### 3. DISCLOSURE OF THE INVENTION

This new invention, a temperature-maintenance zero-cooking utensil, uses 5 safety-operation modes, of which three functions take priority:

water bath for an average temperature;
stabilization (water bath+cold) for a hot temperature;
cooling for a high temperature;
plus two other secondary safety functions.
The standby function comprises an OFF button equipped with a circuit-breaker (to switch off the safety functions).

In order to resolve the above-mentioned technical problems, the present invention embodies the following technical solutions.

A command-control system (2), one of the key components, is arranged on top of the handle of the temperature-maintenance zero-cooking utensil. Its function is to assess and control all of the safety systems of the pan or utensil used. It comprises a small energy-supplying solar panel (1) located at the end of the handle of the temperature-maintenance utensil and a small motor (4) incorporated within the utensil handle.

The temperature-maintenance zero-cooking utensil comprises a base (8) that has a pressurized part reserved for the temperature-maintenance safety system to enable the circulation of cooling fluid or distilled water (Elephant's-civ technology) (5). This part, dedicated to the cooling system with its pressurized zone (5), is located between the base (8) and the pan body (9). Electrical wires (10) connect all of the utensil's safety systems together.

The fluid circulates in the connecting pipes (7) and communicates via the sensors (6) by making contact with the body (9) of the temperature-maintenance zero-cooking utensil. Note that at no time, including during other safety functions, does the cooling water or distilled water (Elephant's-civ technology) (5) enter inside the temperature-maintenance zero-cooking utensil to maintain the temperature of the food or foods present in the utensil. The temperature is maintained solely by the cooling liquid or distilled water circulating in its pressurized zone (5), passing through the connecting pipes (7) until reaching the sensors (6) then coming into contact with the body (9) of the pan.

### 4. BRIEF DESCRIPTION OF THE DRAWINGS

FIG. 1 is a structural diagram of a temperature-maintenance zero-cooking saucepan according to the present invention.

FIG. 2 is a structural diagram of a temperature-maintenance zero-cooking circular pot, according to the present invention.

FIG. 3 is a structural diagram of a temperature-maintenance zero-cooking frying pan, according to the present invention.

FIG. 4A-B is a structural diagram of a temperature-maintenance zero-cooking pot viewed from the inside, according to the present invention.

### 5. DETAILED DESCRIPTION

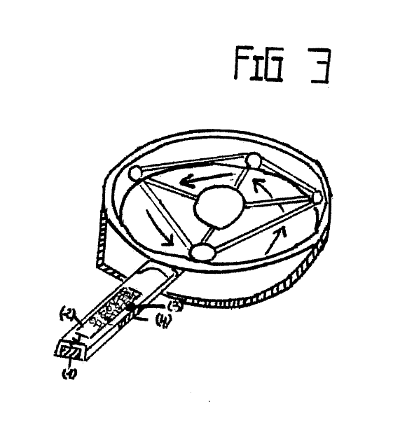

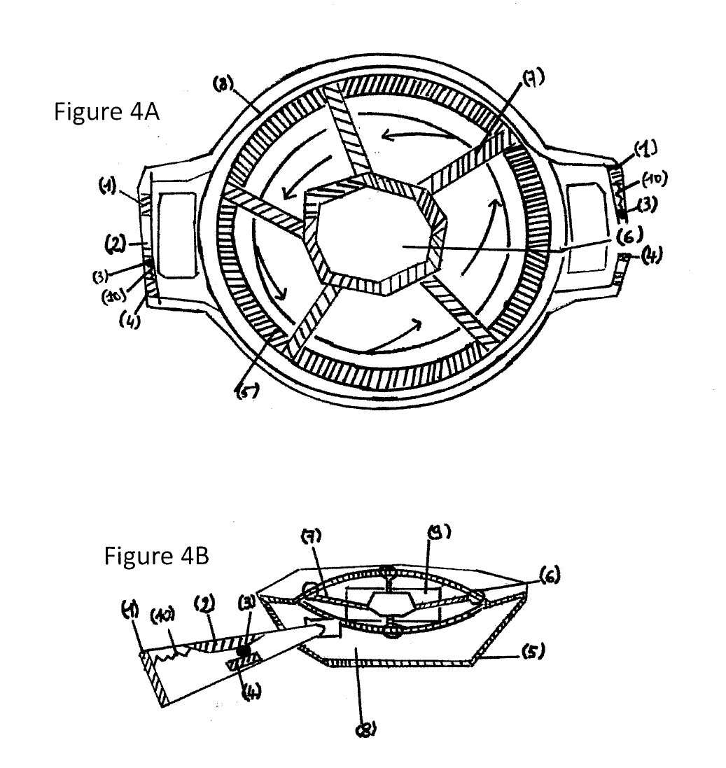

The combination of FIGS. 2 and 4 illustrate different embodiments of the present invention.

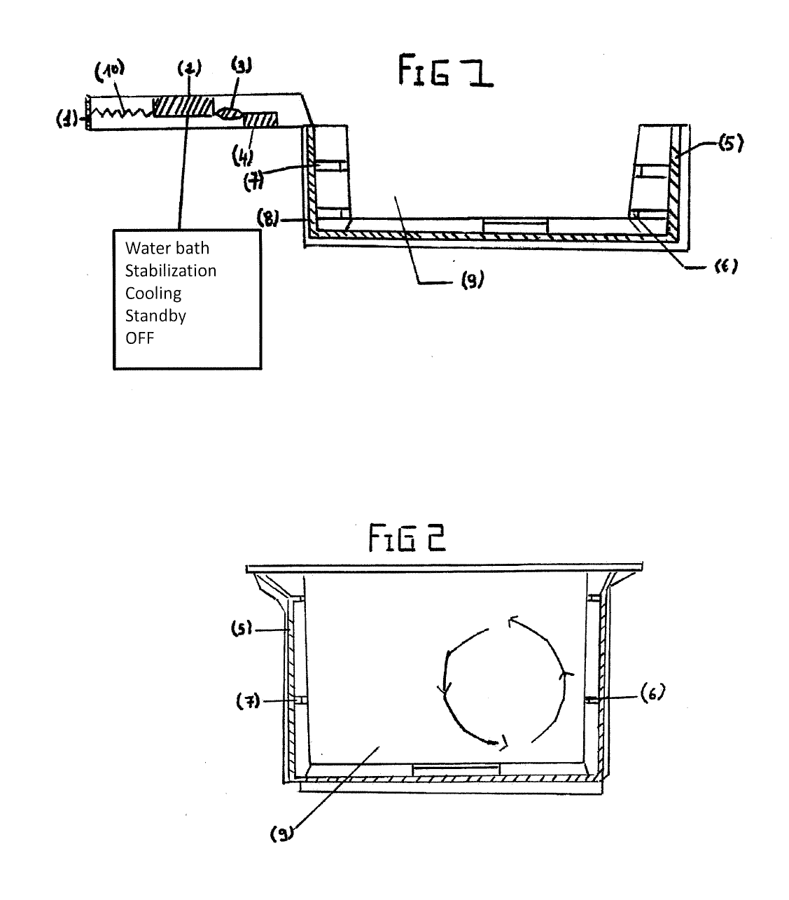

FIG. 1 illustrates an exemplary embodiment of the present invention.

FIG. 2 illustrates an exemplary embodiment of the present invention.

### 5.1 First Embodiment

As shown in FIGS. 2 and 4A-B, the temperature-maintenance pot consists of a small energy-supplying solar panel (1), a command control system (2), an OFF button (circuit-breaker) (3), a small motor (4), a pressurized zone (5) with its cooling liquid or distilled water (Elephant's-civ technology), sensors (6), connecting pipes (7), a base (8), a pan body (9) and electrical wires (10).

The temperature-maintenance zero-cooking utensil is equipped with a command control system (2), which is arranged on top of the utensil handle.

At the end of the handle of the temperature-maintenance zero-cooking utensil is a small solar panel (1) that powers and supplies energy to a small motor (4) that is incorporated within the handle of the temperature-maintenance zero-cooking utensil.

The command control system (2) equipping the temperature-maintenance zero-cooking utensil assesses whether it is necessary to trigger a temperature-maintenance, water-bath, stabilization (water bath+cold)- or cooling-safety mode.

A stand-by function comprises an OFF button, which is a circuit-breaker that supports the rest of the temperature-maintenance safety functions. This temperature-maintenance zero-cooking utensil has 5 safety functions. If necessary, even during its assessment, this command control system (2) can operate mainly in water-bath, stabilization (water bath+cold)- and cooling-mode at the same time. In this state, the stand-by and OFF functions remain secondary.

The command control system (2) is electrically connected to the small solar panel (1) supplying energy to it and to its small motor (4). These are connected by connecting pipes (7).

By means of its command control system (2), the saucepan (FIG. 1), the frying pan (FIG. 3) or the utensil used, can, by a contact made via its sensors (8), activate its various safety operating modes of water bath, stabilization (water bath+cold) or cooling of the temperature-maintenance zero-cooking utensil. These cooking-safety sensors (6) are located between the base (8) and the pan body (9) of the utensil by connecting pipes (7).

A liquid (5), for a type of cooling known as Elephant's-civ (liquid nitrogen), or distilled water is also provided. This liquid circulates through a pressurized zone (5) passing through the connecting pipes (7) until reaching the sensors (6) between the base (8) and the pan body (9), then makes contact with the pan body. The cooling liquid or distilled water (5) circulates in a cycle and passes through the connecting pipes (7) of the utensil to be cooled that are closest to the heat zone to be made safe. When the utensil that is on the heat source reaches a high temperature, it will pass into safe mode, by means of the command control system (2), connected to the sensors (6). The utensil will assume one of its cooking-temperature safety modes. Its command control system (2), assessing the different temperature variations, will determine precisely the best temperature-maintenance mode to be assumed in order to make the heat zone safe. The temperature-maintenance zero-cooking utensil could therefore pass into water-bath mode for an average temperature, into stabilization mode for a hot temperature or into total cooling mode, the latter in the event of a very hot temperature with the risk of the food in the utensil being burnt.

The command control system (2) can remain on standby if it considers that none of its safety-operation modes is necessary. Clearly, a person could switch off its safety functions by pressing the OFF button if he considers them unnecessary simply because he is present.

As an optimization, the small solar panel (1) of the utensil will recharge itself and draw power when it is employed in cooking over the heat source (utensils are compatible with all heat sources), from whence its energy will automatically redistribute power to the functions that require it.

When the temperature-maintenance zero-cooking utensil enters into safety mode due to significant overheating, it will perform a cyclone action from the bottom upwards in order to achieve a better distribution of safety temperature-maintenance in water-bath, stabilization (water bath+cold)- or cooling mode. Indeed all 3 are performed at the same time during a cyclone action.

### 5.2 Second Embodiment

As shown in FIGS. 2 and 4, FIG. 1 and FIG. 3, the temperature-maintenance zero-cooking utensil comprises a command control system (2) in order to activate the functions of water-bath mode for a medium temperature, stabilization (water bath+cold) mode for a hot temperature or cooling mode for a high temperature. The standby function comprises an OFF button (3) (circuit-breaker).

### 5.3 Third Embodiment

As shown in FIGS. 2 and 4, the temperature-maintenance pot consists of a small solar panel (1), a command control system (2), a small motor (4) and electrical wires (10) located in the grips of the temperature-maintenance pot.

As an optimization, the cooling liquid or distilled water (Elephant's-civ technology), contained in its pressurized zone (5), circulates round the right and left sides and between the body (9) and base (8) of the pan. The above-mentioned sensors (6) and connecting pipes (7) are arranged round the sides and beneath the body (9) of the pan.

In FIG. 1, the temperature-maintenance pan comprises a small solar panel (1) arranged at the end of the utensil's handle. An OFF/circuit-breaker button (3) is arranged between the command control system (2) and the small motor (4).

A pressurized zone (5) with its cooling liquid or distilled water (Elephant's-civ technology) is located between the base (8) and body (9) of the pan. The above-mentioned sensors (6) and connecting pipes (7) are arranged round the right and left sides, between the base (8) and body (9) of the pan, and electrical wires (10) are also provided.

FIG. 3 shows a temperature-maintenance frying pan that comprises a small solar panel (1), arranged at the end of the utensil's handle, a command control system (2), located on the top of the handle, an OFF/circuit-breaker button (3), arranged between the command control system (2) and the small motor (4), and a pressurized zone (5) with its cooling liquid or distilled water (Elephant's-civ technology), located between the base (8) and body (9) of the pan. The above-mentioned sensors (6) and connecting pipes (7) are arranged round the right and left sides, between the base (8) and the body (9) of the pan, and electrical wires (10) are provided.

1. A temperature-maintenance pan, comprising:
a pan body attached to a pan handle,
a small solar panel that powers a small motor,
a command control system,
an OFF button,
a pressurized zone with cooling liquid or distilled water,
sensors,
connecting pipes,
a base, and
electrical wires.

2. The temperature-maintenance pan according to claim 1, wherein the small solar panel is arranged at the end of the pan handle.

3. The temperature-maintenance pan according to claim 1, wherein the command control system is arranged on the top of the pan handle.

4. The temperature-maintenance pan according to claim 1, wherein the command control system has 5 safety-function modes, 3 of which take priority: water bath, stabilization (water bath+cold) and cooling, plus 2 other secondary modes: standby and OFF button.

5. The temperature-maintenance pan according to claim 1, wherein the command control system is electrically connected to the solar panel and the small solar panel to the small motor via the connecting pipes.
